(19) United States
(12) Patent Application Publication
(10) Pub. No.: US 2022/0312147 A1
(43) Pub. Date: Sep. 29, 2022

(54) PROXIMITY-BASED OFFLINE GEOFENCING

(71) Applicant: HERE Global B.V., Eindhoven (FI)

(72) Inventors: Marko LUOMI, Lempäälä (FI); Mika VIITALA, Tampere (FI)

(21) Appl. No.: 17/432,420

(22) PCT Filed: Feb. 19, 2019
(86) PCT No.: PCT/EP2019/054018

§ 371 Date: Aug. 19, 2021

(51) Int. Cl. H04W 4/021; H04W 4/029; H04W 4/70

(52) U.S. Cl. CPC H04W 4/021; H04W 4/029; H04W 4/70

(57) ABSTRACT

Inter-alia, a method is disclosed comprising: generating a proximity geofence at least partially based on at least one stored radio map, wherein the proximity geofence is indicative of an area, wherein a limited memory capacity device is enabled to determine whether or not it is located within the area, wherein a geofence borders the area, wherein the proximity geofence is limited to comprising identifying information of one or more radio nodes which one or more respective coverage areas, in which radio signals sent by a respective radio node of the one or more radio nodes are observable, at least partially overlap with the coverage of the area of the proximity geofence, and wherein the at least one stored radio map is indicative of information identifying one or more radio nodes located in a geographical area that comprises the area of the proximity geofence; and providing the proximity geofence. It is further disclosed an according apparatus, computer program and system.

### FIELD

The following disclosure relates to the field of indoor positioning, or more particularly relates to systems, apparatuses, and methods for offline geofencing in indoor and outdoor positioning, in particular offline geofencing in limited memory capability devices.

### BACKGROUND

Satellite signal based positioning technologies, which are mainly used outdoors, are usually not suited to deliver a satisfactory performance when used for indoor positioning, since satellite signals of global navigation satellite systems (GNSS), like the global positioning system (GPS) or the Galileo system, do not penetrate through walls and roofs strongly enough for an adequate signal reception indoors. Thus, these positioning technologies are not able to deliver a performance indoors that would enable seamless, equal and accurate navigation experience outdoors and indoors.

Therefore, several dedicated non-GNSS based radio positioning systems for indoor and outdoor positioning have been developed and commercially deployed during the past years. Examples comprise systems that are based on pseudolites, which are ground based GPS-like short-range beacons, ultra-sound positioning systems, Bluetooth Low Energy (BLE) based positioning systems, cellular network based positioning systems and wireless local area network (WLAN) based positioning systems.

Such a non-GNSS based radio positioning system (e.g. a self-contained positioning system) may be divided in at least three stages: an installation stage, a training stage and a positioning stage.

In the installation stage, dedicated positioning support radio nodes (e.g. Bluetooth beacons) may be installed in the environment for which a positioning system is to be provided. Alternatively or additionally, a non-GNSS based radio positioning system may make use of existing radio nodes like WLAN access points or cellular network nodes as positioning support radio nodes.

In the subsequent training stage, positioning data are collected. The data may be collected in the form of radio fingerprint observation reports (also referred to as radio scans or fingerprints) that are based on measurements e.g. by mobile devices. A radio fingerprint observation report may indicate an observation position and radio signal parameters obtained as a result of measurements taken from the radio interface when scanning for observable radio signals at the observation position. Measurements taken from the radio interface may comprise, by way of example, measured received signal strengths values and identifiers of radio nodes (e.g. Bluetooth beacons, WLAN access points, base stations of a cellular network) transmitting the radio signals observable at the observation position. The training may be a continuous background process, in which mobile devices of a large number of consumers are continuously reporting collected fingerprint observation reports to a server. Consumers may consent to a participation in such a radio fingerprint observation report collection, if their device is equipped with the needed functionality. This approach is also referred to as crowd-sourcing. Since crowd-sourcing is a background process that does not directly benefit the device user, it is desirable that the crowd-sourcing process only consumes limited resources of the device.

Alternatively or additionally, mobile devices may be used for collecting radio fingerprint observation reports in a systematic manner. Collected reports may be uploaded to a database e.g. in a positioning server or in a positioning cloud, where algorithms may be run to generate radio models of positioning support devices (e.g. radio nodes such as a Bluetooth beacons, WLAN access points, base stations of a cellular network) and/or radio maps for positioning purposes.

In the positioning stage, a mobile device may estimate its current position based on own measurements taken from the radio interface and on information or a subset of information that is available from the training stage. Radio model information or radio map information that has been generated in the training stage may be provided e.g. to mobile devices by a positioning server via the Internet as assistance information for use in position estimation. Alternatively, radio model information and/or radio map information (also referred to as radio map) may be stored in a positioning server to which e.g. the mobile devices may connect to via the Internet for obtaining a position estimate.

When tracking people or objects based on their position, geofencing is often used to trigger different events such as notifications. From a power respective energy consumption point of view, it is often beneficial to determine the position of the device as well as the estimate whether or not a device is inside the geofence locally in the device (offline). Resolving geofences this manner minimizes also the need for data transmission between a client and a server.

Traditional implementation of offline geofencing is based on offline positioning. Certain devices like low end IoT (Internet-of-Things) devices have so limited memory capacity that offline network positioning client implementation is not feasible, especially offline indoor network positioning clients, which require quite a bit of memory for code and offline radio maps. Such devices are also referred to as limited memory capability devices.

Typical solution based on offline network positioning operates as follows:
1. Geofences are defined as geographical areas and related triggering actions at server;
2. Geofence definitions are pushed to client;
3. Client resolves its position based on the offline radio maps that have been downloaded from server and on radio signal observation reports (so-called fingerprints);
4. Based on the resolved position estimates, client checks if any of the geofence actions trigger; and
5. The server is contacted only when new geofence action has triggered.

### Summary of Some Exemplary Embodiments

However, as such solutions are great, they cannot be implemented to all IoT devices, in particular with IoT devices with limited memory capability.

It is thus, inter alia, an object of the invention to enable offline network geofencing even in limited memory capability devices, in particular limited memory capability devices which are not able to determine an actual position estimate offline.

According to a first exemplary aspect of the present invention, a method is disclosed, the method comprising:
generating a proximity geofence at least partially based on at least one stored radio map, wherein the proximity geofence is indicative of an area, wherein a limited memory capacity device is enabled to determine whether or not it is located within the area, wherein a geofence borders the area, wherein the proximity geofence is limited to comprising identifying information of one or more radio nodes which one or more respective coverage areas, in which radio signals sent by a respective radio node of the one or more radio nodes are observable, at least partially overlap with the coverage of the area of the proximity geofence, and wherein the at least one stored radio map is indicative of information identifying one or more radio nodes located in a geographical area that comprises the area of the proximity geofence; and
providing the proximity geofence.

This method may for instance be performed and/or controlled by an apparatus, for instance a server. Alternatively, this method may be performed and/or controlled by more than one apparatus, for instance a server cloud comprising at least two servers.

According to a further exemplary aspect of the invention, a computer program is disclosed, the computer program when executed by a processor causing an apparatus, for instance a server, to perform and/or control the actions of the method according to the first exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect of the invention, an apparatus is disclosed, configured to perform and/or control or comprising respective means for performing and/or controlling the method according to the first exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect of the invention, an apparatus is disclosed, comprising at least one processor and at least one memory including computer program code, the at least one memory and the computer program code configured to, with the at least one processor, cause an apparatus, for instance the apparatus, at least to perform and/or to control the method according to the first exemplary aspect.

The above-disclosed apparatus according to any aspect of the invention may be a module or a component for a device, for example a chip. Alternatively, the disclosed apparatus according to any aspect of the invention may be a device, for instance a server or server cloud. The disclosed apparatus according to any aspect of the invention may comprise only the disclosed components, for instance means, processor, memory, or may further comprise one or more additional components.

According to a second exemplary aspect of the present invention, a method is disclosed, the method comprising:
receiving a proximity geofence, wherein the proximity geofence is indicative of an area in which the second apparatus is enabled to determine whether or not it is located within the area, wherein a geofence borders the area, wherein the proximity geofence is limited to comprising identifying information of one or more radio nodes which one or more respective coverage areas, in which radio signals sent by a respective radio node of the one or more radio nodes are observable, at least partially overlap with the coverage of the area of the proximity geofence; and
utilizing the proximity geofence in a geofencing.

This method may for instance be performed and/or controlled by an apparatus, for instance an electronic device, e.g. a limited memory capability device, or an IoT device with limited memory capability. For instance, the method may be performed and/or controlled by using at least one processor of the electronic device.

According to a further exemplary aspect of the invention, a computer program is disclosed, the computer program when executed by a processor causing an apparatus, for instance a server, to perform and/or control the actions of the method according to the second exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect of the invention, an apparatus is disclosed, configured to perform and/or control or comprising respective means for performing and/or controlling the method according to the second exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect of the invention, an apparatus is disclosed, comprising at least one processor and at least one memory including computer program code, the at least one memory and the computer program code configured to, with the at least one processor, cause an apparatus, for instance the apparatus, at least to perform and/or to control the method according to the second exemplary aspect.

The above-disclosed apparatus according to any aspect of the invention may be a module or a component for a device, for example a chip. Alternatively, the disclosed apparatus according to any aspect of the invention may be a device, for instance a server or server cloud. The disclosed apparatus according to any aspect of the invention may comprise only the disclosed components, for instance means, processor, memory, or may further comprise one or more additional components.

According to a third exemplary aspect of the invention, a system is disclosed, comprising: A first apparatus according to the first exemplary aspect of the invention as disclosed above, and a second apparatus according to the second exemplary aspect of the invention as disclosed above.

In the following, exemplary features and exemplary embodiments of all aspects of the present invention will be described in further detail.

A respective geofence may for instance be a virtual perimeter of a real-world geographical area. Entering or exiting the perimeter by the apparatus according to the second exemplary aspect of the present invention may for instance trigger a pre-defined (e.g. geofence) action.

Geofencing, as used herein, may for instance refer to an act of triggering a pre-defined action when entering or exiting a geofence perimeter.

A radio map comprises or represents a model of a radio network (e.g. WiFi) coverage, created and maintained by a service provider, e.g. of a positioning server (e.g. a position-based service). Such a radio map is used for positioning purposes.

A respective proximity geofence, as used herein, refers to an information that may for instance be provided to a limited memory capability device, which is generated at least partially based on a (positioning) radio map. Such a proximity geofence includes minimal set of information about radio network needed for geofencing purposes. This can be derived from one or more positioning radio maps. Such a radio map is a model of an electromagnetic field generated by radio node(s) (e.g. WLAN access point, BLE beacon or cell base station) with respect to geographical coordinates. A respective proximity geofence, as used herein, loses direct references to geographical coordinates in contrast to such a radio map. Further, a respective proximity geofence potentially only maintains one or more (unique) identifiers (e.g. WLAN MAC (Medium Access Control) Addresses, BSSIDs (Basic Service Set Identifiers), to name but a few non-limiting examples) of selected radio nodes. Thus, a respective proximity geofence may for instance not be used for actual positioning, because it may be limited to only determine based on a radio measurement (e.g. radio scan) that is performed if the respective apparatus that performed the radio measurement is in close enough proximity of one or more radio nodes as comprised or represented by the respective proximity geofence. The actual locations of the radio nodes and therefore the location of the measurements may for instance not be needed to be known. However, such a proximity geofence may still comprise or represent enough information to trigger a geofence action that is defined by a geofence that e.g. borders one or more coverage areas (or their unions or intersections) of those pre-defined radio nodes.

Offline positioning, as used herein, refers to a method of a client side positioning that doesn't require active network connections.

Offline geofencing, as used herein, refers to a method of client side geofencing that doesn't require active network connections.

In order to enable a solution for geofencing on (e.g. IoT-) devices with limited memory capacity, it is proposed to generate (e.g. create) a new “type of radio map”, a so-called “proximity geofence”. This proximity geofence comprises or includes minimal set of information about e.g. WiFi access points needed for resolving geofencing rules. For instance, it doesn't need to contain the full radio model for the included radio nodes (e.g. WiFi access points because the purpose is not to provide actual position estimate. The geofences can be instead resolved based on the proximity of known radio nodes with reasonable accuracy. Therefore, it can be much smaller than the offline radio maps are. Further, such a proximity geofence may for instance not enable a respective apparatus (e.g. according to the second exemplary aspect of the present invention) to determine its position, e.g. in a positioning. For more reliable results, the proximity based geofence resolution can provide an estimate for uncertainty. This type of proximity geofence is generated for each geofence associated with and/or provided to a respective apparatus (e.g. according to the second exemplary aspect of the present invention; e.g. a limited capability device) at a server at least partially based on the existing radio data for indoor and outdoor positioning, such as a radio map. When proximity geofences are pushed from a server to a client (e.g. a respective apparatus according to the second exemplary aspect of the present invention; e.g. a limited capability device), the client can resolve one or more geofences offline.

This type of solution is ideal for small memory footprint IoT devices, such as limited memory capability devices, and use cases where continued positioning is not a must. A good example is tracking of assets where the objective is to understand if assets have left or entered certain points of interests (geofences), like warehouses, factories, harbors, etc.

The respective apparatus(es) performing and/or controlling the method according to the first and/or second exemplary aspects of the present invention may be enabled for support of a non-GNSS based radio positioning system. This may be understood to mean that the apparatus performing and/or controlling the method according to the second exemplary aspect of the present invention is configured to estimate (e.g. determine) or to cause estimating (e.g. determining) whether or not it is located within the area of the proximity geofence at least partially based on a (e.g. gathered) radio scan, e.g. comprising or representing radio signal parameters of one or more radio signals (e.g. one or more terrestrial radio signals) obtained at a current position (e.g. obtained as a scanning result of scanning for observable radio signals at this position) of the apparatus. Further, this apparatus may for instance request a respective position estimate to be determined based on the gathered radio scan, so that it may for instance receive the respective position estimate from the apparatus performing and/or controlling the method according to the first exemplary aspect of the present invention. The latter case may for instance be performed and/or controlled in case the apparatus performing and/or controlling the method according to the second exemplary aspect of the present invention may for instance not be enabled to determine whether or not it is located within the area of the proximity geofence with a high degree of certainty.

This may be understood to mean that the position estimate determined by the apparatus according to the first exemplary aspect of the present invention is configured to estimate (e.g. determine) or to cause estimating (e.g. determining) a position of the apparatus according to the second exemplary aspect of the present invention at least partially based on a non-GNSS-based positioning system, thus, e.g. based on (e.g. gathered) signals of respective radio nodes comprised by such a non-GNSS positioning system. Further, estimating (e.g. determining) of such a position estimate at least partially based on (a) radio signal parameter(s) may be understood to mean that the estimating is performed as a function of the radio signal parameter(s).

The proximity geofence may for instance be much smaller in its size than the at least one (e.g. complete) radio map or a part of it. Therefore, the apparatus according to the second exemplary aspect of the present invention may for instance be able to store such a proximity geofence without reaching its limited memory capabilities.

For example, such a (e.g. complete) radio map may for instance be stored by a server, e.g. the apparatus according to the first exemplary aspect of the present invention. Such a radio map may be configured to enable one or more mobile devices (e.g. smartphones, tablets, wearables, portable navigation devices, IoT devices, to name but a few non-limiting examples) to request estimate(s) of their position at least partially based on this radio map when e.g. mobile devices are located in the area covered by the radio map. For example, the radio map is represented by radio map information which may be hold available by such a server for the respective mobile devices (e.g. stored in memory means of the server). For example, the radio map contains or represents a respective radio model for a plurality of radio nodes transmitting (e.g. broadcasting) radio signals that are observable within an area covered by the radio map. If the radio map covers a venue (e.g. building), the radio map may contain or represent, e.g. for each floor of the venue, a respective radio model for a plurality of radio nodes transmitting (e.g. broadcasting) radio signals that are observable on the respective floor of the venue.

Such a radio node of the plurality of radio nodes may be a specific WiFi, Bluetooth, cellular, or a combination thereof enabled radio node. For instance, a specific radio node of one or more radio nodes may for instance be identified by its identifier (ID). Thus, the identifier of at least one radio node of the one or more radio nodes may for instance be stored in an accessible database, e.g. as disclosed above, or via the Internet, to identify the respective radio node. Further, based on a respective identifier, for instance, the position of the respective radio node may for instance be determined. To name but one non-limiting example, the respective identifier may be associated with its current position (e.g. in the form of coordinates; x- and y-coordinates or latitude- and longitude-coordinates) so that the position of the respective radio node is at least determinable at least partially based on its identifier.

Such (a) radio node(s) of plurality of radio nodes may for instance be used for indoor positioning and/or floor detection, e.g. according to Bluetooth- and/or BLE-specification, or may for instance be a WiFi access point for indoor positioning and/or floor detection, e.g. according to the WLAN—(Wireless Local Area Network) specification.

Such (a) radio node(s) of the plurality of radio nodes, e.g. of a certain venue or its section, and/or of a certain floor or its section, may for instance comprise or be connectable to a transceiver, e.g. according to the BT-, BLE, and/or WLAN-specification to provide wireless-based communication. Each radio node of the one or more radio nodes may for instance use such a transceiver for transmitting and/or broadcasting one or more radio signals, e.g. comprising or containing one or more information (e.g. an identifier of the respective radio node) and/or radio signal parameters.

A respective radio model for a respective radio node, as disclosed above, may be understood to represent at least the expected radio coverage of the respective radio node (e.g. on a certain floor of a building). For example, the radio model of such a radio node may describe the coverage area (e.g. on a certain floor of a venue) within which radio signals transmitted or triggered to be transmitted by this radio node are expected to be observable. An example for such a radio model is a radio image representing an expected radio signal strength field of the radio signals transmitted or triggered to be transmitted by this radio node. The real radio coverage of such a radio positioning support device may however deviate from the expected radio coverage as described by such a radio model.

Such one or more radio signals may be terrestrial radio signals. Examples of such a terrestrial radio signal are a Bluetooth signal, a BLE signal, a cellular network signal or a WLAN signal. The Bluetooth standards are specified by the Bluetooth Special Interest Group and are presently available under https://www.bluetooth.com/. A cellular network may for example be a mobile phone network like a 2G/3G/4G/5G cellular communication network. The 2G/3G/4G/5G cellular radio communication standards are developed by the 3GPP and presently available under http://www.3gpp.org/. WLAN is for example specified by the standards of the IEEE 802.11 family (http://www.ieee.org/).

A radio signal parameter of a certain radio signal may for example be obtained, by a limited memory capability device as a scanning result when scanning for observable radio signals at a certain position (e.g. for estimating its position). Therein, a radio signal may be understood to be observable at a certain position if the radio signal is receivable with a minimum quality (e.g. a minimum signal-to-noise ratio and/or a minimum signal power, e.g. at least −90 dBm or −95 dBm) at this position. For example, a respective limited memory capability device (e.g. the at least one mobile device) may determine at least one respective radio signal parameter for each radio signal observed when scanning for radio signals at a certain position. The determined radio signal parameters may then for example be obtained as scanning results.

A radio signal parameter of a certain radio signal may be understood to be at least one of (1) an information contained in the radio signal and (2) a representation (e.g. an indicator or a value) of a physical quantity (e.g. a received signal strength) of the radio signal. Accordingly, a radio signal parameter may be determined by at least one of (1) extracting information contained in the radio signal and (2) measuring a physical quantity (e.g. a received signal strength) of the radio signal.

As disclosed above, such a radio map may for instance comprise or represent a plurality of information that may be in their respective size too large to be stored in particular by a limited memory capability device (e.g. an IoT device, e.g. the apparatus for performing and/or controlling the method according to the second exemplary aspect of the present invention).

Therefore, in order to enable an offline geofencing to be performed by such a limited memory capability device (e.g. an IoT device, e.g. the apparatus for performing and/or controlling the method according to the second exemplary aspect of the present invention), the proximity geofence is generated at least partially based on such a radio map stored by the apparatus for performing and/or controlling the method according to the first exemplary aspect of the present invention (e.g. a server or a server cloud).

As disclosed above, the at least one stored radio map may for instance be stored in a memory, e.g. comprising a database. Such a memory may for instance be comprised by or be connectable to the apparatus performing and/or controlling the method according to the first exemplary aspect of the present invention. Optionally, such a database may for instance be maintained. The maintaining of such a database may for instance be referred to as keeping the database. The database, or the at least one radio map stored in the database, may for instance be available upon a certain request so that e.g. independent upon a communication connection information of the database, it can be retrieved to be further utilized, e.g. for generating a respective proximity geofence at partially based on such at least one stored radio map locally. It will be understood that such a retrieving of at least one stored radio map may for instance be performed and/or controlled by the apparatus performing and/or controlling the method according to the first exemplary aspect, while one or more further steps of the method according to the first exemplary aspect of the present invention are performed and/or controlled.

The at least one stored radio map may for instance be at least indicative of information identifying one or more radio nodes located in a geographical area that comprises the area with its perimeter being the geofence of the proximity geofence to be generated.

The proximity geofence is associated with or indicative of an area, wherein a limited memory capacity device is enabled to determine whether or not it is located within the area. The area may for instance be a geographical area, e.g. a two-dimensional geographic area. The limited memory capacity device may for instance be the apparatus performing and/or controlling the method according to the second exemplary aspect of the present invention.

The geofence borders the area. The proximity geofence is limited to identifying information of one or more radio nodes which one or more respective coverage areas, in which radio signals sent by a respective radio node are observable, at least partially overlap with the coverage of the area of the proximity geofence. The borders may for instance represent the perimeter of the area. The geofence may for instance be understood to trigger one or more geofence actions in case the limited memory capability device (e.g. the apparatus according to the second exemplary aspect) enters into the area, thus crossing the geofence from the outside of the area into the inside of the area, and/or exiting respectively leaving the area, thus crossing the geofence from the inside of the area to the outside of the area.

The geofence may for instance be formed e.g by a respective coverage area of a single radio node (e.g. WLAN access point), or one or more intersections of one or more coverage areas of multiple radio nodes, or their subset when restricting the areas with additional information such as required received signal strength of radio signals sent by the respective radio nodes (e.g. RX power).

According to an exemplary embodiment of all exemplary aspects of the present invention, the area is defined by one of the following:
i) geographical coordinates of the area that is bordered by the geofence; or
ii) by one or more identifiers of one or more radio nodes which respective one or more coverage areas form the area that is bordered by the geofence.

According to an exemplary embodiment of all exemplary aspects of the present invention, a respective proximity geofence is utilized to determine an estimate of accuracy, e.g. when triggering at least one geofence action with respect to how likely a geofence perimeter was actually crossed (e.g. the respective apparatus according to the second exemplary aspect has entered or exited the area). The estimate of accuracy may for instance be represented by an uncertainty value.

Further, a respective proximity geofence may for instance be generated (e.g. created) for one or more geofences that should be utilized by a limited memory capability device (e.g. the apparatus performing and/or controlling the method according to the second exemplary aspect of the present invention), or by a plurality of limited memory capability devices, wherein the respective proximity geofence(s) are generated at the apparatus performing and/or controlling the method according to the first exemplary aspect of the present invention (e.g. a server) at least partially based on existing radio data for indoor and outdoor positioning, e.g. comprised or represented by the at least one stored radio map. This enables a generating of a plurality of proximity geofences, e.g. for a plurality of limited memory capability devices to be very easy, since it can be automated if a network positioning system e.g. comprising the apparatus performing and/or controlling the method according to the first exemplary aspect of the present invention (e.g. a server) is in use. After each generating of a respective proximity geofence of a plurality of such proximity geofences, a respective generated proximity geofence may for instance be provided to a respective limited memory capability device which was intended to utilize the respective generated proximity geofence. Of course, also a plurality of such proximity geofences can be provided simultaneously to a respective plurality of limited memory capability devices.

According to an exemplary embodiment of all exemplary aspects of the present invention, the steps of gathering a radio scan (e.g. radio network fingerprinting) performed and/or controlled by the apparatus of the second exemplary aspect of the present invention, and the step of generating a proximity geofence (e.g. geofence creation) may for instance be decoupled. This may for instance enable to use existing radio models, as comprised or represented by the at least one stored radio map, to define a wide variety of different shaped and sized geofences on any areas with radio model coverage and change them dynamically without need to collect additional radio scans (e.g. radio network fingerprints).

Furthermore, a respective proximity geofence may for instance be generated at least partially based on at least one (stored) radio map that does not have full coverage of the (geofenced) area of the proximity geofence to be generated. Such a proximity geofence may for instance be generated at least partially based on previously constructed radio models of one or more radio nodes, which may for instance be extrapolated from incomplete source data, e.g. comprised by or represented by the at least one stored radio map, to name but one non-limiting example.

The (generated) proximity geofence may for instance be provided, e.g. to a limited memory capability device (e.g. the (second) apparatus performing and/or controlling the method according to the second exemplary aspect of the present invention).

A respective proximity geofence may for instance be provided e.g. to a certain limited memory capability device at least partially based on a respective identifier of the limited memory capability device. Additionally or alternatively, a respective proximity geofence may for instance be provided to a respective limited memory capability device, or to a plurality (e.g. at least two) of respective limited memory capability device at least partially based on one or more respective identifiers. For instance, only a respective limited memory capability device of the plurality of limited memory capability device may for instance be provided with a respective proximity geofence, wherein this respective proximity geofence may for instance not be relevant to the other limited memory capability devices.

Furthermore, in case a respective limited memory capability device may for instance have moved, e.g. a new proximity geofence may for instance be generated. After the generation, the proximity geofence may for instance be provided to the limited memory capability device. In this way, e.g. the amount of information respectively data to be transmitted between the apparatus performing and/or controlling the method according to the first exemplary aspect of the present invention and the apparatus (e.g. limited memory capability device) performing and/or controlling the method according to the second exemplary aspect of the present invention may for instance be kept low.

A respective proximity geofence may for instance be provided by outputting the respective proximity geofence, e.g. via a communication interface enabling communication between the apparatus (e.g. server) performing and/or controlling the method according to the first exemplary aspect of the present invention and the apparatus (e.g. limited memory capability device) performing and/or controlling the method according to the second exemplary aspect of the present invention.

Alternatively, the apparatus (e.g. server) performing and/or controlling the method according to the first exemplary aspect of the present invention may for instance output a respective proximity geofence to another entity that is different from the apparatus (e.g. limited memory capability device) performing and/or controlling the method according to the second exemplary aspect of the present invention, and/or to one or more components responsible for a cloud-based positioning in a location-based service, and which transmits (e.g. relay) the respective proximity geofence to the apparatus (e.g. limited memory capability device) performing and/or controlling the method according to the second exemplary aspect of the present invention.

The proximity geofence may for instance be provided to be utilized in offline geofencing, thus, the respective apparatus (e.g. according to the second exemplary aspect of the present invention) may for instance not be required to have established any kind of communication connection. The proximity geofence may for instance be provided, e.g. by outputting (e.g. sending) the proximity geofence via a push method and/or by outputting it via an API (Application Programming Interface) to a respective limited memory capability device, e.g. the apparatus performing and/or controlling the method according to the second exemplary aspect of the present invention.

According to an exemplary embodiment of the first exemplary aspect of the present invention, the generating of the proximity geofence further comprises:
determining the area by defining the borders of the area.

The borders of the area may for instance be of any size and shape. The borders of the area may for instance encircle an (e.g. geographical) area. The borders may for instance be one or more line segments closing in a loop to form a closed shape. The borders forming a closed shape may for instance represent a geofence. Such a geofence may for instance enable comparing a position to the borders of the area, so that it may for instance be determined whether or not the position in inside or outside of the area surrounded by the geofence. Additionally or alternatively, such a geofence may for instance enable comparing a series of positions (e.g. a tracking of positions) to the borders of the area, so that it may for instance be determined whether or not a limited memory capability device has exited or entered the area surrounded by the geofence.

According to an exemplary embodiment of the first exemplary aspect of the present invention, the generating of the proximity geofence further comprises:
determining the one or more radio nodes that are located within the area at least partially based on the information identifying one or more radio nodes of the at least one stored radio map.

In this way, e.g. the proximity geofence is generated by determining (e.g. selecting) the information identifying the one or more radio nodes (e.g. necessary identification data of each respective radio node of the one or more radio nodes, such as an identifier (e.g. SSID (Service Set Identifier); BSSID (Basic Service Set Identifier); UUID (Universally Unique Identifier); MAC address, or the like, to name but a few non-limiting examples)). The one or more radio nodes that are determined may for instance be one or more radio nodes that are located within the area of the proximity geofence. Optionally, this area was determined by defining the borders of the area, e.g. as represented by the geofence of the proximity geofence. For instance, a generated proximity geofence may for instance comprise a list of one or more identifiers (e.g. BSSIDs) of the one or more radio nodes that are location inside the area.

The geofence may for instance be defined and/or represented e.g. explicitly by one or more (e.g. unique; e.g. BSSIDs) identifiers of one or more radio nodes, or by defining the area geographically (e.g. by one or more coordinates, such as latitude-, longitude-coordinates, or x-, y-coordinates) and resolving a list (e.g. comprised or represented, at least partially, by the at least one stored radio map) of one or more (e.g. unique) identifiers of one or more radio nodes programmatically. Optionally, a signal strength threshold may for instance be comprised or included by the respective proximity geofence, e.g. to exclude cases where the signal of a defined radio node (thus its respective identifier is comprised or represented by the respective proximity geofence) is weak, which may for instance indicate a more distant proximity).

According to an exemplary embodiment of the first exemplary aspect of the present invention, the generating of the proximity geofence further comprises:
including (e.g. only) one or more identifiers of the determined one or more radio nodes in the generated proximity geofence.

In particular, such a generated proximity geofence may for instance comprise only the list of the one or more identifiers (e.g. BSSIDs) of the one or more radio nodes.

The one or more radio nodes that are located within the area are determined, e.g. by determining (e.g. selecting) the one or more radio nodes which respective coverage area (e.g. in the form of a coverage ellipse) may for instance have an intersection with the border (e.g. perimeter) of the area of the proximity geofence.

Alternatively or additionally, for instance, the one or more radio nodes whose respective coverage area has an intersection with the area of the proximity geofence are determined to be comprised by or included in the proximity geofence. It will be understood that the determined one or more radio nodes may for instance be comprised by the proximity geofence, e.g. by including (e.g. only) the respective identifiers of the determined one or more radio nodes in the generated proximity geofence.

According to an exemplary embodiment of the first exemplary aspect of the present invention, the generating of the proximity geofence further comprises:
determining one or more position estimates, wherein each respective position estimate of the one or more position estimates is indicative of a position of one of the one or more radio nodes whose respective position is estimated to be located within the area.

As disclosed above, the at least one radio map may be determined, e.g. by a positioning server during a training stage of a non-GNSS based radio positioning system. Causing of determining (e.g. estimating) of a position, e.g. of the apparatus performing and/or controlling the method according to the second exemplary aspect of the present invention (e.g. a limited memory capability device) at least partially based on the radio signal parameter(s) may be understood to mean that the radio signal parameter(s) are provided (e.g. transmitted) by a respective limited memory capability device to a server (e.g. the apparatus performing and/or controlling the method according to the first exemplary aspect of the present invention) to cause the server to determine a position of the respective limited memory capability device at least partially based e.g. on the radio signal parameter(s).

Such a determining of a respective position estimate may for instance not be limited to the determining of a position estimate of a respective limited memory capability device, but a position estimate e.g. of a respective radio node of one or more radio nodes. For instance, such a radio node may for instance gather a radio scan of one or more radio signals observable at its location. This radio scan may for instance be output by the respective radio node to a positioning server (e.g. the apparatus performing and/or controlling the method according to the first exemplary aspect of the present invention). After the obtaining (e.g. reception) of the radio scan, the server may for instance determine the position estimate of the respective radio node. This may for instance be used to determine one or more radio nodes whose respective position is estimated to be located within the area of a respective proximity geofence to be generated.

Furthermore and optionally, a respective determined position estimate can be output, e.g. to the entity from which e.g. an obtained request and/or radio scan stems, or to another entity that is different from the entity from which the obtained radio scan stems, and which transmits (e.g. relays) the output position estimate to the entity from which the obtained radio scan stems. The position estimate may for instance be output via the communication interface of the apparatus performing and/or controlling the method according to the first exemplary aspect of the present invention. Such a communication interface may for instance comprise one or more radio transceivers (e.g. transmitter and receiver), e.g. according to WLAN-, BT-, BLE-, cellular-communication standard, or a combination thereof, to name but a few non-limiting examples.

According to an exemplary embodiment of all exemplary aspects of the present invention, each respective position estimate of the one or more position estimate is determined at least partially based on the assumption that a respective radio node is located in the center of its respective coverage area.

Another option to determine one or more position estimates, wherein each respective position estimate of the one or more position estimates is indicative of a position of one of the one or more radio nodes whose respective position is estimated to be located within the area, is to use the assumption that a respective radio node is located in the center of its respective coverage area. Then, in case the position of the respective radio node is within the area of the proximity geofence to be generated (e.g. surrounded by the defined geofence), this respective radio node respectively its identifier may for instance be comprised by or represented by the proximity geofence when it is generated.

According to an exemplary embodiment of the first exemplary aspect of the present invention, the generating of the proximity geofence further comprises:
including one or more received signal strengths values of the determined one or more radio nodes in the generated proximity geofence.

Such one or more received signal strengths values of the one or more radio nodes may for instance be one or more radio signal parameters, as disclosed above. Such one or more received signal strengths values of the one or more radio nodes may for instance be comprised by or represented by the at least one radio map, based on which the proximity geofence is generated. Including such one or more received signal strengths values of the one or more radio nodes in the proximity geofence may increase the size of the proximity geofence, and further may enhance the accuracy of determining e.g. whether or not a respective geofence should be triggered, e.g. by the apparatus performing and/or controlling the method according to the second exemplary aspect of the present invention.

According to an exemplary embodiment of the first exemplary aspect of the present invention, the generated proximity geofence is provided to a limited memory capacity device.

The limited memory capacity device may for instance be portable (e.g. weigh less than 1, 0.5, 0.4, 0.2, or 0.1 kg). The limited memory capacity device may for instance comprise or be connectable to one or more sensors for determining the devices position, such as for instance a magnetic field receiver. The limited memory capacity device may for instance comprise or be connectable to one or more sensors, e.g. in the form of an accelerometer and/or a gyroscope for gathering (e.g. measuring) further information (e.g. radio measurements). The limited memory capacity device may for instance comprise or be connectable to a receiver and/or a transmitter (e.g. a transceiver) for receiving and/or sending data and/or information. For instance, the limited memory capacity device may comprise one or more radio receivers (e.g. radio transceivers, e.g. cellular radio transceivers), which may for instance enable the method according to the second exemplary aspect of the present invention to be performed and/or controlled. The limited memory capacity device may for instance be suitable for outdoor and/or indoor navigation respectively positioning. The limited memory capacity device may for instance comprise or be connectable to means for storing information, e.g. a memory for storing a proximity geofence. In particular, the limited memory capacity device may for instance comprise the means for storing (e.g. only) a proximity geofence, which enables the limited memory capacity device to perform and/or control offline positioning. The means for storing may for instance be limited to storing just such one or more proximity geofences.

The apparatus performing and/or controlling the method according to the second exemplary aspect of the present invention may for instance be such a limited memory capacity device.

The generated proximity geofence may for instance be provided from the apparatus performing and/or controlling the method according to the first exemplary aspect of the present invention to such a limited memory capacity device, e.g. by a push-method enabling pushing the proximity geofence to the limited memory capacity device, e.g. via a communication connection.

According to an exemplary embodiment of the first exemplary aspect of the present invention, the method further comprises:
providing one or more geofence rules indicative of one or more geofence actions to be triggered in case the limited memory capability device enters or exits the area of the geofence; and/or
receiving at least one geofence action (e.g. from the limited memory capacity device) comprising a request to assist the limited memory capacity device in performing the at least one geofence action.

One or more geofence rules may for instance be provided, e.g. to the apparatus performing and/or controlling the method according to the second exemplary aspect of the present invention. Optionally, the one or more geofence rules may for instance be comprised or represented by the proximity geofence. Thus, the one or more geofence rules may for instance be provided together with the proximity geofence, since the one or more geofence rules may for instance be comprised by or be a part of the proximity geofence.

The one or more geofence rules may for instance be indicative of one or more geofence actions. A respective geofence action may for instance be executed, e.g. by the apparatus performing and/or controlling the method according to the second exemplary aspect of the present invention, in case this apparatus moves out of the area (e.g. exits) or moves into the area (e.g. enters) of the proximity area. Whether or not this apparatus exits or enters the area, thus crosses the geofence of the proximity geofence, may thus be determined at least partially based on the respective proximity geofence without need or ability to determine (e.g. calculate) a position estimate indicative of a respective position of the apparatus performing and/or controlling the method according to the second exemplary aspect of the present invention.

In case e.g. the apparatus performing and/or controlling the method according to the second exemplary aspect of the present invention enters or exits the area of the proximity geofence (e.g. enters or exits the geofence), the apparatus performing and/or controlling the method according to the first exemplary aspect of the present invention may for instance receive at least one geofence action which was triggered by the apparatus performing and/or controlling the method according to the second exemplary aspect of the present invention. Such a received at least one geofence action may for instance comprise or represent a request to assist the limited memory capacity device, e.g. requesting a new proximity geofence to be generated, to determine a more accurate position estimate by the apparatus performing and/or controlling the method according to the first exemplary aspect of the present invention, or a notification to the apparatus performing and/or controlling the method according to the first exemplary aspect of the present invention, or to another apparatus, or the like, to name but a few non-limiting examples.

After the apparatus performing and/or controlling the method according to the first exemplary aspect of the present invention has generated a proximity geofence, this generated proximity geofence may for instance be provided to the apparatus performing and/or controlling the method according to the second exemplary aspect of the present invention. In this way, the apparatus performing and/or controlling the method according to the second exemplary aspect of the present invention may for instance receive the proximity geofence. Then, the apparatus performing and/or controlling the method according to the second exemplary aspect of the present invention may for instance utilize the proximity geofence, e.g. determine whether or not it (the apparatus according to the second exemplary aspect of the present invention) may for instance have entered or exited the area of the proximity geofence, thus may for instance have crossed the defined geofence, e.g. as comprised or represented by the proximity geofence.

The apparatus performing and/or controlling the method according to the second exemplary aspect of the present invention (e.g. a limited memory capability device) utilizing the received proximity geofence (e.g. applying a geofence) may for instance not require a) information of absolute positions of radio nodes, and/or b) may for instance not need to determine (e.g. calculate) an actual position estimate.

According to an exemplary embodiment of all exemplary aspects of the present invention, the geofence enables triggering at least one geofence action that is part of the geofencing.

For instance, together with the proximity geofence, e.g. one or more geofence rules indicative of one or more geofence actions that may for instance be performed and/or controlled by the apparatus performing and/or controlling the method according to the second exemplary aspect of the present invention.

As disclosed above, the geofence (virtually) surrounds a (e.g. geographical) area. In case the apparatus performing and/or controlling the method according to the second exemplary aspect of the present invention may for instance enter or exit the surrounded area, thus crosses the geofence, at least one geofence action, e.g. a geofence action comprised by or represented by one or more geofence rules (e.g. comprised by or a part of the received proximity geofence) may for instance be triggered.

According to an exemplary embodiment of all exemplary aspects of the present invention, the at least one geofence action is indicative of requesting a position estimate to be determined, wherein the further position estimate is indicative of a current position of the second apparatus that is determined at least partially based on the gathered radio scan. For instance, such a position estimate may for instance be determined by a position-based service, e.g. the server representing the apparatus according to the first exemplary aspect of the present invention; e.g. at least partially based on the gathered radio scan the position of the second apparatus is determined by an external server, e.g. based on ‘normal’ radio map positioning, to name but one non-limiting example.

Such a position estimate may for instance be requested to be determined, so that e.g. the apparatus performing and/or controlling the method according to the first exemplary aspect of the present invention may for instance determine it. For instance, such a respective geofence action may for instance be represented by a positioning request, which, when the respective geofence action is triggered, may for instance be sent to a positioning server (e.g. the apparatus performing and/or controlling the method according to the first exemplary aspect of the present invention) by the one apparatus performing and/or controlling the method according to the second exemplary aspect of the present invention. Such a positioning request may for instance comprise or represent an identifier of the respective apparatus performing and/or controlling the method according to the second exemplary aspect of the present invention (e.g. a limited memory capability device) whose position is requested to be determined. In response to such a positioning request, a position estimate indicative of an estimated position of the respective limited memory capability device may for instance be received. Such a position estimate may for instance be in the form of coordinates, e.g. x-, y-coordinates, and/or latitude-, longitude-coordinates. Optionally, such a position estimate may for instance comprise or represent a three-dimensional position, e.g. in the form of three-dimensional coordinates (e.g. x-, y-, z-coordinates, and/or latitude-, longitude-, altitude-coordinates). In order to determine a position estimate, such a positioning server may for instance utilize a radio map (e.g. the at least one radio map in case the positioning server is represented by the apparatus performing and/or controlling the method according to the first exemplary aspect of the present invention, as disclosed above).

The apparatus performing and/or controlling the method according to the second exemplary aspect of the present invention receives the proximity geofence. After the proximity geofence is received, the method according to the second exemplary aspect of the present invention may for instance further comprise:
storing the received proximity geofence, e.g. in a memory, e.g. comprised by or connectable to the apparatus performing and/or controlling the method according to the second exemplary aspect of the present invention.

According to an exemplary embodiment of the second exemplary aspect of the present invention, the utilizing of the proximity geofence comprises:
gathering a radio scan (e.g. a fingerprint) of one or more radio signals sent by one or more (e.g. near-by) radio nodes, wherein the one or more radio signals are observable at the position at which the apparatus is located; and
determining whether or not the second apparatus is located within the area, wherein the determining is at least partially based on the the gathered radio scan.

A respective radio node may for instance be considered to be a near-by radio node within the meaning of the present invention, in case a respective coverage area of the respective radio node at least partially intersects with a certain radius around the current position of the apparatus performing and/or controlling the method according to the second exemplary aspect of the present invention. Thus, such a respective radio node does not need to be the one of the one or more radio nodes that is comprised by the received proximity geofence (respectively its respective identifier is comprised or represented by the received proximity geofence), since the apparatus performing and/or controlling the method according to the second exemplary aspect of the present invention (e.g. the limited memory capability device (e.g. an IoT device)) could have moved, so that one or more further respectively other radio node are near-by radio node, as defined above, to the apparatus performing and/or controlling the method according to the second exemplary aspect of the present invention.

According to an exemplary embodiment of the second exemplary aspect of the present invention, the utilizing of the proximity geofence further comprises:
receiving one or more geofence rules indicative of one or more geofence actions to be triggered in case a position of the apparatus when entering or exiting the area of the geofence;
determining whether or not one or more geofence rules are fulfilled at least partially based on the received proximity geofence; and
triggering the at least one geofence action based on the result of the determining.

The determining whether or not one or more geofence rules are fulfilled may for instance be performed and/or controlled according to the following exemplary embodiment of all exemplary aspects of the present invention:

According to an exemplary embodiment of the second exemplary aspect of the present invention, the proximity geofence is further utilized to determine an uncertainty indicative of the position of the second apparatus diverging from an actual position of the second apparatus.

The uncertainty may for instance be an uncertainty radius. The uncertainty may for instance indicate that a position of the apparatus performing and/or controlling the method according to the second exemplary aspect of the present invention is not exact. The uncertainty may for instance be indicative of that the position of the apparatus performing and/or controlling the method according to the second exemplary aspect of the present invention may for instance be within the area as represented by the proximity geofence, or be indicative of that the position of the apparatus performing and/or controlling the method according to the second exemplary aspect of the present invention may for instance not be within the area as represented by the proximity geofence.

According to an exemplary embodiment of the second exemplary aspect of the present invention, the radio scan comprises extracting a respective identifier of a respective radio node which radio signals are observable at the position at which the apparatus is located.

For instance, at a current position at which the radio scan is gathered (e.g. measured) one or more radio signals of one or more radio nodes may for instance be observable. Out of these one or more radio signals sent by the one or more radio nodes, e.g. the apparatus that gathered the radio scan, may for instance extract one or more identifiers that are comprised by a respective radio signal of the one or more radio signals. In this way, it may for instance be enabled to determine the one or more radio nodes which respective radio signals are observable at the current location at which the respective radio scan was gathered. Furthermore, a respective identifier may for instance be utilized to determine the position of the respective radio node, e.g. since such a respective position may for instance be stored in a database, so that at least partially based on a respective identifier of a respective radio node, it may for instance be enabled to determine (e.g. derive) the position of the respective radio node since the position may for instance be stored in the database, e.g. stored during the installation stage of a non-GNSS positioning system, as disclosed above.

According to an exemplary embodiment of the second exemplary aspect of the present invention, the radio scan further comprises measuring a respective received signal strength value with which a respective radio signal of a respective radio node is observable at the position at which the apparatus is positioned.

It will be understood that at a certain location, at which the radio scan is gathered, the apparatus gathering the radio scan may for instance determine a respective received signal strength value of a respective radio signal of the one or more radio signals that are observable at the location at which the radio scan is gathered (e.g. measured).

According to an exemplary embodiment of the second exemplary aspect of the present invention, the radio scan further comprises determining a number of radio nodes which respective radio signals are observable at the position at which the apparatus is located.

For instance, based on the number of radio nodes which respective radio signals are observable at the position at which the apparatus is located, it may for instance be determinable whether or not the apparatus performing and/or controlling the method according to the second exemplary aspect of the present invention is located within the area as represented by the received proximity geofence. This may for instance be utilized to trigger (e.g. the) at least one geofence action (e.g. comprised by the one or more geofence rules that may for instance be comprised or a part of the received proximity geofence).

The features and example embodiments of the invention described above may equally pertain to the different aspects according to the present invention.

It is to be understood that the presentation of the invention in this section is merely by way of examples and non-limiting.

Other features of the invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE DRAWINGS

In the figures show:

FIG. 1 a schematic block diagram of a system according to the third exemplary aspect of the present invention;

FIG. 2 a flowchart showing an example embodiment of a method according to the first exemplary aspect of the present invention;

FIG. 3 a flowchart showing an example embodiment of a method according to the second exemplary aspect of the present invention;

FIG. 4 a schematic block diagram of an apparatus configured to perform the method according to the first exemplary aspect of the present invention;

FIG. 5 a schematic block diagram of an apparatus configured to perform the method according to the second exemplary aspect of the present invention; and

FIG. 6 is a schematic illustration of examples of tangible and non-transitory storage media according to the present invention.

### DETAILED DESCRIPTION OF SOME EXEMPLARY EMBODIMENTS

The following description serves to deepen the understanding of the present invention and shall be understood to complement and be read together with the description as provided in the above summary section of this specification.

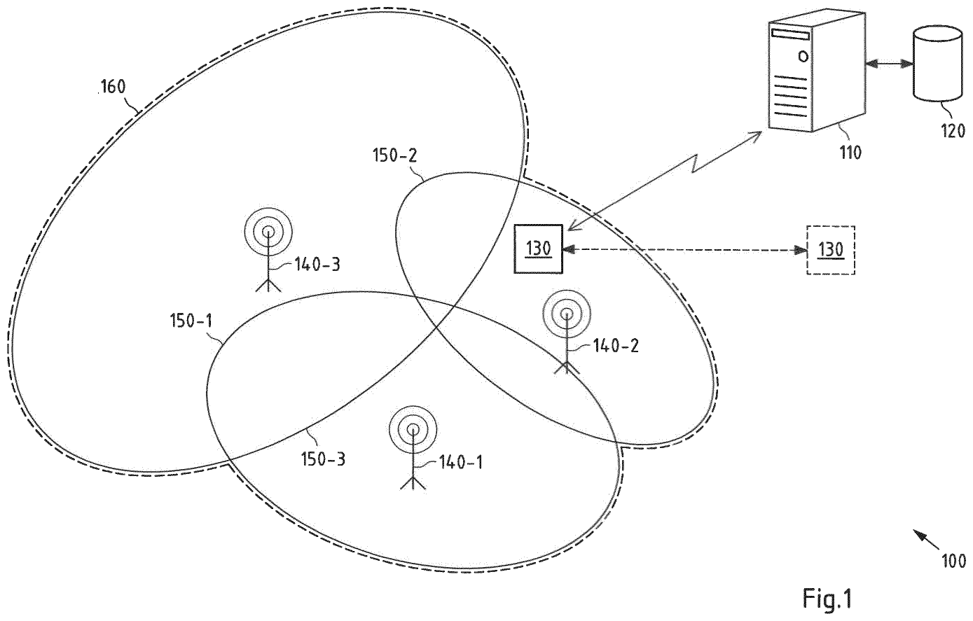

FIG. 1 is a schematic high-level block diagram of a system 100 according to the third exemplary aspect of the present invention. Such a system 100 may for instance represent a generic system architecture as used by one or more exemplary embodiments according to all exemplary aspects of the present invention.

System 100 comprises a server 110, an optional database 120, at least one IoT device (in particular a limited memory capability device) 130, one or more radio nodes, from which three radio nodes 140-1, 140-2 and 140-3 are shown. Further, in FIG. 1 coverage areas 150-1 to 150-3 are shown, which illustrate a respective (geographic) area in that radio signals sent by the respective radio nodes 140-1 to 140-3 are observable, e.g. by IoT devices (e.g. IoT device 130).

In FIG. 1, it is schematically shown a geofence 160 with a dotted line. The geofence 160 surrounds the coverage areas 150-1 to 150-3 of the respective radio nodes 140-1 to 143-3. Furthermore, it is schematically illustrated that IoT device 130 can move out of the geofence and move back into the geofence, which is illustrated by the dotted double arrow between the two instances of the IoT device 130.

Each of the respective coverage areas 150-1 to 150-3 of the respective radio nodes 140-1 to 140-3 covers the area of the perimeter of the geofence 160. Thus, a proximity geofence that may for instance be provided from server 110 (after it is generated by server 110 at least partially based on one or more radio maps, e.g. stored in database 120 comprised by or connectable to server 110) to IoT device 130, may for instance only comprise at present three identifiers of the three radio nodes 140-1 to 140-3. Of course, further radio nodes not shown in FIG. 1 may for instance be in the vicinity of the area bordered by the geofence 160 of the proximity geofence, but which respective coverage areas may for instance not at least partially overlap with the area with the perimeter of the geofence 160.

The server 110 may alternatively be embodied as a server cloud (e.g. a plurality of server connected, e.g. via a communication network such as the Internet, and providing services at least partially jointly. The server 110, which may for instance be embodied as a positioning server, may for instance be further configured to generate and provide a proximity geofence, e.g. to IoT device 130. Furthermore, server 110 may for instance be configured to provide one or more radio maps to other entities which comprise memory capabilities for storing the provided one or more radio maps, in contrast to IoT device 130 which memory may for instance not be sufficient to store such a respective radio map.

The database 120 may for instance be optional. The database 120 may for instance comprise a memory, e.g. for storing one or more radio maps, one or more proximity geofence that may for instance be generated at least partially based on the one or more radio maps (e.g. by server 110). Furthermore, database 120 may for instance store one or more identifiers of one or more radio nodes, e.g. one or more identifiers of the radio nodes 140-1 to 140-3. It will be understood that the database 120 may for instance also store an identifier of one or more IoT devices, such as IoT device 130, for instance to store an association (e.g. link) between a generated proximity geofence and a respective IoT device which may for instance be intended to utilize the generated proximity geofence.

The IoT device 130 may for instance be configured to perform and/or control the method according to the second exemplary aspect of the present invention. The server 110 may for instance be configured to perform and/or control the method according to the first exemplary aspect of the present invention.

The system 100 may for instance enable the following example embodiment according to all aspects of the present invention:
1. One or more geofences (comprised or represented by respective proximity geofences) for respective IoT devices (e.g. IoT device 130) are defined as geographical areas and related to triggering actions (e.g. represented by one or more geofence rules) at server 110.
2. Based on the geographical presentation of geofences, the geofence radio map, thus a proximity geofence, is generated (e.g. created) by the server 110, e.g. by determining (e.g. selecting) the necessary identification data (e.g. identifiers) of radio nodes (e.g. radio nodes 140-1 to 140-3) that are located within the defined geofence 160. Minimal implementation could include just a list of identifiers (e.g. BSSIDs) of each radio node 140-1 to 140-3 comprised or represented by the respective proximity geofence, which respective coverage areas (e.g. coverage ellipses) 150-1 to 150-3 have e.g. an intersection with the defined geofence 160 perimeter. Naïve implementation for radio node position estimate is to assume that the respective radio node is in the center of its respective coverage area (e.g. coverage ellipse), but also other more precise methods could be used. Additional information such as radio node signal strength thresholds could be included into proximity geofence to be generated by server 110.
3. Triggering actions (e.g. one or more geofence rules) and geofence radio maps (e.g. proximity geofences) are provided (e.g. pushed) to one or more clients (e.g. IoT device 130).
4. Client(s) (e.g. IoT device 130) make(s) radio scans to detect nearby radio node(s).
5. Client(s) (e.g. IoT device 130) resolve(s) geofencing rules using the offline proximity geofence(s) that have been provided (e.g. downloaded) from server 110. Client (e.g. IoT device 130) could use additional information such as radio node signal strength and/or number of discovered matching radio nodes as a way to increase geofence triggering accuracy.
6. The server 110 is contacted only when new geofence action has triggered, or optionally when the results provided by the proximity based solution are too uncertain.

This approach enables offline geofencing for IoT devices with very limited memory footprint, such as IoT device 130. It also minimizes the need for data transmission and makes offline geofencing calculations less demanding for the client.

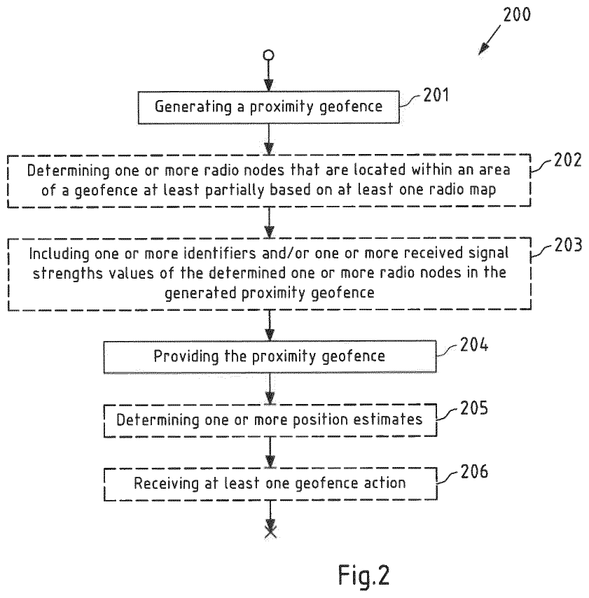

FIG. 2 is a flowchart 200 showing an example embodiment of a method according to the first exemplary aspect of the present invention. This flowchart 200 may for instance be performed by a server or a server cloud, e.g. server 110 of FIG. 1.

In a first step 201, a proximity geofence is generated. The proximity geofence may for instance be generated at least partially based on at least one radio map. Such at least one radio map may for instance be stored in a database, e.g. database 120 of FIG. 1. Such at least one radio map may for instance be generated in a training stage of a non-GNSS positioning system, e.g. as disclosed above. The proximity geofence may for instance be generated by at least one processor, e.g. processor 410 of apparatus 400 in case apparatus 400 represents the server or the server cloud performing and/or controlling the flowchart 200.

In an optional second step 202, one or more radio nodes that are located within an area of the geofence of the proximity geofence (see step 201) are determined at least partially based on at least one radio map. The at least one radio map may for instance be the at least one radio map stored in the database 120 of FIG. 1. The determining may for instance be executed by at least one processor, e.g. processor 410 of apparatus 400 in case apparatus 400 represents the server or the server cloud performing and/or controlling the flowchart 200.

In an optional third step 203, one or more identifiers and/or one or more received signal strengths values of the determined (see step 202) one or more radio nodes are included into the generated proximity geofence. The one or more received signal strengths values may for instance be comprised or stored in the database 120, as well. The determining may for instance be executed by at least one processor, e.g. processor 410 of apparatus 400 in case apparatus 400 represents the server or the server cloud performing and/or controlling the flowchart 200.

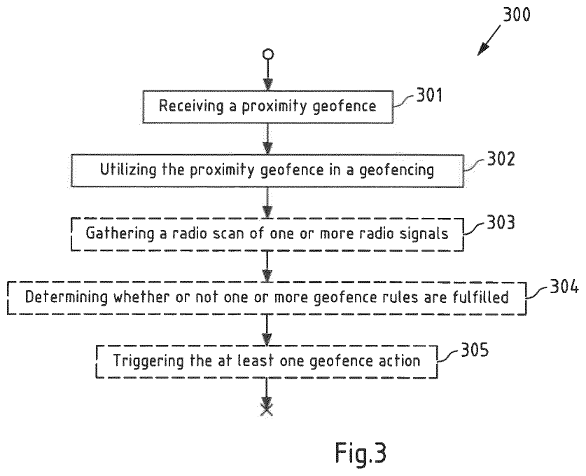

In a fourth step 204, the proximity geofence is provided, e.g. via a communication interface (e.g. communication interface(s) 450 in case apparatus 400 represents the server or the server cloud, e.g. server 110 of FIG. 1). The proximity geofence may for instance be provided (e.g. sent) to at least one limited memory capability device (e.g. IoT device 130 of FIG. 1). Such at least one limited memory capability device may for instance be configured to perform and/or control flowchart 300 of FIG. 3.

In an optional fifth step 205, one or more position estimates are determined. The one or more position estimates may for instance be determined, e.g. at least partially based on a radio scan that may for instance be obtained (e.g. received), e.g. from at least one limited memory capability device (e.g. IoT device 130 of FIG. 1). Alternatively or additionally, such a radio scan may for instance be obtained (e.g. received), e.g. from at least one radio node (e.g. at least one of the radio nodes 140-1 to 140-3 of FIG. 1). For instance, the at least one limited memory capability device (e.g. IoT device 130 of FIG. 1) and/or the at least one radio node (e.g. at least one of the radio nodes 140-1 to 140-3 of FIG. 1) may for instance gather (e.g. measure) the respective radio scan, and then transmit (e.g. sent) the gathered radio scan to the server or the server cloud. The determining of the position estimate may for instance be executed by at least one processor, e.g. processor 410 of apparatus 400 in case apparatus 400 represents the server or the server cloud performing and/or controlling the flowchart 200.

In an optional sixth step 206, at least one geofence action is received. For instance, apparatus 500 performing and/or controlling flowchart 300 of FIG. 3 may for instance have executed step 305, in which at least one geofence action is triggered. Such a geofence action may for instance be a request for assistance that is requested by apparatus 500 from apparatus 400 performing and/or controlling flowchart 200 of FIG. 2, or a notification. The at least one geofence action may for instance be received via a communication network. Thus, the at least one geofence action may for instance be received via a communication interface (e.g. communication interface(s) 450 in case apparatus 400 performs and/or controls flowchart 200 of FIG. 2).

FIG. 3 is a flowchart 300 showing an example embodiment of a method according to the second exemplary aspect of the present invention. This flowchart 300 may for instance be performed by a limited memory capability device, e.g. an IoT device. This flowchart 300 may for instance be performed by the limited memory capability device, e.g. IoT device 130 of FIG. 1.

In a first step 301, a proximity geofence is received e.g. via a communication interface (e.g. communication interface(s) 550 in case apparatus 500 represents the limited memory capability device, e.g. IoT device 130 of FIG. 1). The proximity geofence may for instance be provided (e.g. sent) to the limited memory capability device (e.g. IoT device 130 of FIG. 1) by a server or a server cloud (e.g. server 110 of FIG. 1). Such a server or server cloud may for instance be configured to perform and/or control flowchart 200 of FIG. 2.

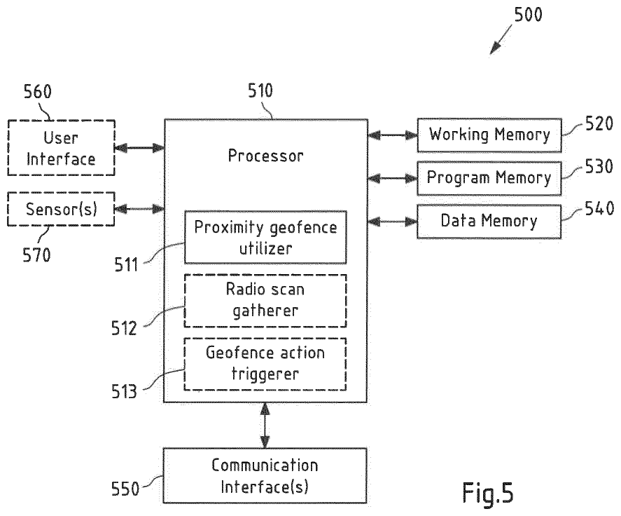

In a second step 302, the proximity geofence is utilized in a geofencing After the proximity geofence is received in step 301, the received proximity geofence may for instance be stored, e.g. in a memory (e.g. memory 540 in case apparatus 500 of FIG. 5 performs and/or controls flowchart 300 of FIG. 3).

In an optional third step 303, a radio scan of one or more radio signals is gathered. The radio scan may for instance be gathered by measuring one or more radio signals that are sent by one or more radio nodes (e.g. the radio nodes 140-1 to 140-3 of FIG. 1). The one or more radio signals that are gathered may for instance be observable at a current position of the limited memory capability device. For instance, radio nodes 140-1 to 140-3 of FIG. 1 may for instance be observable in case IoT device 130 of FIG. 1 is located within the geofence area 160 of FIG. 1. In case IoT device 130 of FIG. 1 is located outside of the geofence area 160 of FIG. 1, or has e.g. moved from being inside of the geofence area 160 of FIG. 1 to the outside of the geofence area 160 of FIG. 1 (as is schematically illustrated by two IoT devices and the dotted double arrow between those schematically illustrated IoT devices), one or more radio signals of one or more further or other radio nodes (e.g. at least one radio node not shown in FIG. 1) may for instance be observable at the position outside of the geofence area 160 of FIG. 1. The radio scan may for instance be performed and/or controlled by a communication interface (e.g. communication interface(s) 550 of FIG. 5 in case apparatus 500 of FIG. 5 is configured to perform and/or control flowchart 300 of FIG. 3).

In an optional fourth step 304, it is determined whether or not one or more geofence rules are fulfilled. The one or more geofence rules may for instance be comprised by or represent a part of the proximity geofence received in step 301. Alternatively or additionally, the one or more geofence rules may for instance be received in a separate step. The receiving of the one or more geofence rules in the latter case may for instance be similar to the receiving of the proximity geofence of step 301.

In an optional fifth step 305, the at least one geofence action is triggered. It may for instance be determinable whether or not e.g. the limited memory capability device has entered or exited e.g. the geofence area 160 of FIG. 1. For instance, the border of the area (e.g. the respective geofence 160) may for instance be comprised by or represented by the proximity geofence of step 301. Alternatively or additionally, the border of the area (e.g. the respective geofence 160) may for instance be comprised by or represented by a respective geofence rule or by one or more geofence rules.

Any of the steps 303 to 305 may for instance be comprised by the step 302. Thus, any of the steps 303 to 305 may for instance be considered to be a use case for utilizing the proximity geofence of step 302.

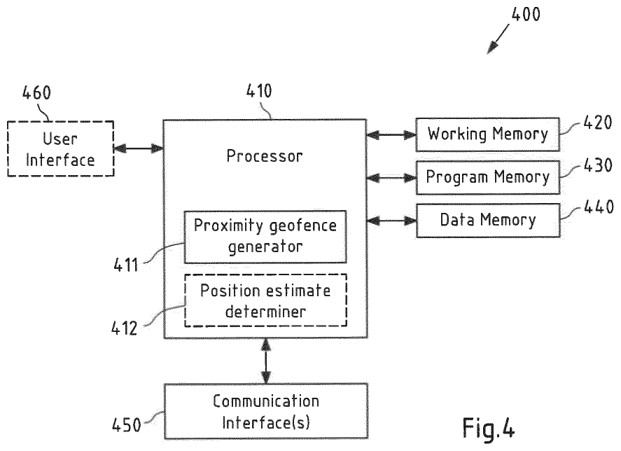

FIG. 4 is a schematic block diagram of an apparatus 400 according to an exemplary aspect of the present invention, which may for instance represent the server 110 of FIG. 1. Apparatus 400 may for instance be configured to perform and/or control the method according to the first exemplary aspect of the present invention.

Apparatus 400 comprises a processor 410, working memory 420, program memory 430, data memory 440, communication interface(s) 450, and an optional user interface 460.

Apparatus 400 may for instance be configured to perform and/or control or comprise respective means (at least one of 410 to 460) for performing and/or controlling the method according to the first exemplary aspect of the present invention. Apparatus 400 may as well constitute an apparatus comprising at least one processor (410) and at least one memory (420) including computer program code, the at least one memory and the computer program code configured to, with the at least one processor, cause an apparatus, e.g. apparatus 400 at least to perform and/or control the method according to the first exemplary aspect of the invention of the present invention.

Processor 410 may for instance comprise a proximity geofence generator 411 as a functional and/or structural unit. Proximity geofence generator 411 may for instance be configured to generate at least one proximity geofence (see step 201 of FIG. 2).

Processor 410 may for instance comprise an optional position estimate determiner 412 as a functional and/or structural unit. Position estimate determiner 412 may for instance be configured to determine a position estimate (see step 205 of FIG. 2).

The communication interface(s) 450 may for instance at least partially be utilized to provide at least one generated proximity geofence (see step 204 of FIG. 2), e.g. to a limited memory capability device (e.g. limited memory capability device 130 of FIG. 1).

Processor 410 may for instance further control the memories 420 to 440, the communication interface(s) 450, and the optional user interface 460.

Processor 410 may for instance execute computer program code stored in program memory 430, which may for instance represent a computer readable storage medium comprising program code that, when executed by processor 410, causes the processor 410 to perform the method according to the first exemplary aspect of the present invention.

Processor 410 (and also any other processor mentioned in this specification) may be a processor of any suitable type. Processor 410 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 410 may for instance be an application processor that runs an operating system.

Program memory 430 may also be included into processor 410. This memory may for instance be fixedly connected to processor 410, or be at least partially removable from processor 410, for instance in the form of a memory card or stick. Program memory 430 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 430 may also comprise an operating system for processor 410. Program memory 430 may also comprise a firmware for apparatus 400.

Apparatus 400 comprises a working memory 420, for instance in the form of a volatile memory. It may for instance be a Random Access Memory (RAM) or Dynamic RAM (DRAM), to give but a few non-limiting examples. It may for instance be used by processor 410 when executing an operating system and/or computer program.

Data memory 440 may for instance be a non-volatile memory. It may for instance be a FLASH memory (or a part thereof), any of a ROM, PROM, EPROM and EEPROM memory (or a part thereof) or a hard disc (or a part thereof), to name but a few examples. Data memory 440 may for instance store one or more proximity geofences, one or more radio maps, one or more pieces of identifying information of one or more radio nodes (e.g. comprised or represented by the one or more radio maps), one or more identifiers and/or one or more received signal strength values of one or more radio nodes (e.g. comprised or represented by the one or more radio maps), one or more position estimates, one or more geofence actions, or a combination thereof, to name but a few non-limiting examples.

Communication interface(s) 450 enable apparatus 400 to communicate with other entities, e.g. with at least one IoT device 130, and/or with at least one of the radio nodes 140-1 to 140-3 of FIG. 1. The communication interface(s) 450 may for instance comprise a wireless interface, e.g. a cellular radio communication interface and/or a WLAN interface) and/or wire-bound interface, e.g. an IP-based interface, for instance to communicate with entities via the Internet.

User interface 460 is optional and may comprise a display for displaying information to a user and/or an input device (e.g. a keyboard, keypad, touchpad, mouse, etc.) for receiving information from a user.

Some or all of the components of the apparatus 400 may for instance be connected via a bus. Some or all of the components of the apparatus 400 may for instance be combined into one or more modules.

FIG. 5 is a schematic block diagram of an apparatus 500 according to an exemplary aspect of the present invention, which may for instance represent limited memory capability device 130 of FIG. 1. Apparatus 500 may for instance be configured to perform and/or control the method according to the second exemplary aspect of the present invention.

Apparatus 500 comprises a processor 510, working memory 520, program memory 530, data memory 540, communication interface(s) 550, and an optional user interface 560 and (an) optional sensor(s) 570.

Apparatus 500 may for instance be configured to perform and/or control or comprise respective means (at least one of 510 to 570) for performing and/or controlling the method according to the second exemplary aspect of the present invention. Apparatus 500 may as well constitute an apparatus comprising at least one processor (510) and at least one memory (520) including computer program code, the at least one memory and the computer program code configured to, with the at least one processor, cause an apparatus, e.g. apparatus 500 at least to perform and/or control the method according to the second exemplary aspect of the invention of the present invention.

Processor 510 may for instance comprise a proximity geofence utilizer 511 as a functional and/or structural unit. Proximity geofence utilizer 511 may for instance be configured to utilize a proximity geofence (see step 302 of FIG. 3).

Processor 510 may for instance comprise an optional radio scan gatherer 512 as a functional and/or structural unit. Radio scan gatherer may for instance be configured to gather a radio scan (see step 303 of FIG. 3).

Processor 510 may for instance comprise an optional geofence action triggerer 513 as a functional and/or structural unit. Geofence action triggerer 513 may for instance be configured to trigger a geofence action (see step 305 of FIG. 3).

Processor 510 may for instance further control the memories 520 to 540, the communication interface(s) 550, the optional user interface 560 and the optional sensor(s) 570.

The communication interface(s) 550 may for instance at least partially be utilized to gather a radio scan, e.g. in alternative or in addition to the optional radio scan gatherer 512.

Processor 510 may for instance be configured to determine whether or not one or more geofence rules (e.g. stored in data memory 540) are fulfilled (see step 304 of FIG. 3). Optionally, processor 510 may for instance comprise a geofence rules determiner as an optional functional and/or structural unit (not shown in FIG. 5).

Processor 510 may for instance execute computer program code stored in program memory 530, which may for instance represent a computer readable storage medium comprising program code that, when executed by processor 510, causes the processor 510 to perform the method according to the second exemplary aspect of the present invention.

Processor 510 (and also any other processor mentioned in this specification) may be a processor of any suitable type. Processor 510 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 510 may for instance be an application processor that runs an operating system.

Program memory 530 may also be included into processor 510. This memory may for instance be fixedly connected to processor 510, or be at least partially removable from processor 510, for instance in the form of a memory card or stick. Program memory 530 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 530 may also comprise an operating system for processor 510. Program memory 530 may also comprise a firmware for apparatus 500.

Apparatus 500 comprises a working memory 520, for instance in the form of a volatile memory. It may for instance be a Random Access Memory (RAM) or Dynamic RAM (DRAM), to give but a few non-limiting examples. It may for instance be used by processor 510 when executing an operating system and/or computer program.

Data memory 540 may for instance be a non-volatile memory. It may for instance be a FLASH memory (or a part thereof), any of a ROM, PROM, EPROM and EEPROM memory (or a part thereof) or a hard disc (or a part thereof), to name but a few examples. Data memory 540 may for instance store at least one proximity geofence, or only one proximity geofence, one or more radio scans, one or more position estimates, one or more geofence rules, one or more geofence actions, or a combination thereof, to name but a few non-limiting examples.

Communication interface(s) 550 enable apparatus 500 to communicate with other entities, e.g. with server 3 of FIG. 1. The communication interface(s) 550 may for instance comprise a wireless interface, e.g. a cellular radio communication interface and/or a WLAN interface) and/or wire-bound interface, e.g. an IP-based interface, for instance to communicate with entities via the Internet. Communication interface(s) may enable apparatus 500 to communicate with other entities, for instance with radio nodes 4-1 to 4-5, and/or 5 of FIG. 1.

User interface 560 is optional and may comprise a display for displaying information to a user and/or an input device (e.g. a keyboard, keypad, touchpad, mouse, etc.) for receiving information from a user.

Sensor(s) 570 are optional and may for instance comprise a barometric sensor, e.g. to gather pressure information.

Some or all of the components of the apparatus 500 may for instance be connected via a bus. Some or all of the components of the apparatus 500 may for instance be combined into one or more modules.

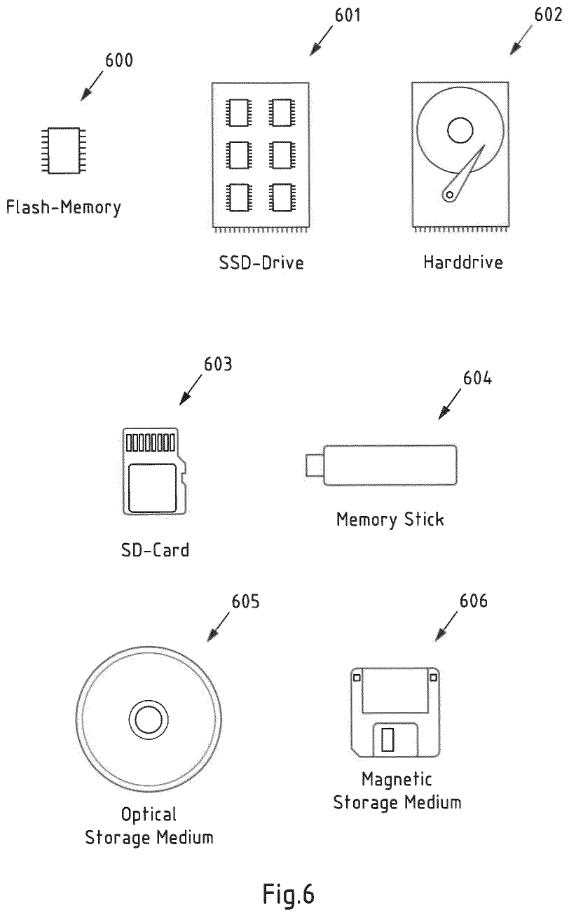

FIG. 6 is a schematic illustration of examples of tangible and non-transitory computer-readable storage media according to the present invention that may for instance be used to implement one or more of the memories 420, 430 of FIG. 4 and/or memories 520, 530 of FIG. 5. To this end, FIG. 6 displays a flash memory 600, which may for instance be soldered or bonded to a printed circuit board, a solid-state drive 601 comprising a plurality of memory chips (e.g. Flash memory chips), a magnetic hard drive 602, a Secure Digital (SD) card 603, a Universal Serial Bus (USB) memory stick 604, an optical storage medium 605 (such as for instance a CD-ROM or DVD) and a magnetic storage medium 606.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)
(b) combinations of circuits and software (and/or firmware), such as: (1) to a combination of processor(s) or (2) to sections of processor(s)/software (including digital signal processor(s)), software, and memory(ies) that work together to cause an apparatus, such as a mobile phone, to perform various functions) and
(c) to circuits, such as a microprocessor(s) or a section of a microprocessor(s), that re-quire software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or section of a processor and its (or their) accompanying software and/or firmware. The term ‘circuitry’ also covers, for example, a baseband integrated circuit or applications processor integrated circuit for a mobile phone.

Any of the processors mentioned in this text, in particular but not limited to processors 310 of FIG. 3, could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

The following embodiments shall also be considered to be disclosed:

### Embodiment 1

A first method, e.g. performed and/or controlled by at least one apparatus, the method comprising:
generating a proximity geofence at least partially based on at least one stored radio map, wherein the proximity geofence is indicative of an area, wherein a limited memory capacity device is enabled to determine whether or not it is located within the area, wherein a geofence borders the area, wherein the proximity geofence is limited to comprising identifying information of one or more radio nodes which one or more respective coverage areas, in which radio signals sent by a respective radio node of the one or more radio nodes are observable, at least partially overlap with the coverage of the area of the proximity geofence, and wherein the at least one stored radio map is indicative of information identifying one or more radio nodes located in a geographical area that comprises the area of the proximity geofence; and providing the proximity geofence.

### Embodiment 2

The method according to embodiment 1, wherein the area is defined by one of the following:
i) geographical coordinates of the area that is bordered by the geofence; or
ii) by one or more identifiers of one or more radio nodes which respective one or more coverage areas form the area that is bordered by the geofence.

### Embodiment 3

The method according to any of the preceding embodiments, wherein the generating of the proximity geofence further comprises:
determining the one or more radio nodes that are located within the area at least partially based on the information identifying one or more radio nodes of the at least one stored radio map.

### Embodiment 4

The method according to any of the preceding embodiments, wherein the generating of the proximity geofence further comprises:
including one or more identifiers of the determined one or more radio nodes in the generated proximity geofence.

### Embodiment 5

The method according to any of the preceding embodiments, wherein the generating of the proximity geofence further comprises:
determining one or more position estimates, wherein each respective position estimate of the one or more position estimates is indicative of a position of one of the one or more radio nodes whose respective position is estimated to be located within the area.

### Embodiment 6

The method according to embodiment 5, wherein

each respective position estimate of the one or more position estimate is determined at least partially based on the assumption that a respective radio node is located in the center of its respective coverage area.

### Embodiment 7

The method according to any of the preceding embodiments, wherein the generating of the proximity geofence further comprises:
including one or more received signal strengths values of the determined one or more radio nodes in the generated proximity geofence.

### Embodiment 8

The method according to any of the preceding embodiments, wherein the generated proximity geofence is provided to a limited memory capacity device.

### Embodiment 9

The method according to any of the preceding embodiments, further comprising:
providing one or more geofence rules indicative of one or more geofence actions to be triggered in case the limited memory capability device enters or exits the area of the geofence; and/or
receiving at least one geofence action comprising a request to assist the limited memory capacity device in performing the at least one geofence action.

### Embodiment 10

The method according to any of the preceding embodiments, wherein the at least one apparatus is a server or a server cloud, or a module or a component for a server or a server cloud.

### Embodiment 11

A second method, e.g. performed by at least one apparatus, comprising:
receiving a proximity geofence, wherein the proximity geofence is indicative of an area, in which an apparatus is enabled to determine whether or not it is located within the area, wherein a geofence borders the area, wherein the proximity geofence is limited to comprising identifying information of one or more radio nodes which one or more respective coverage areas, in which radio signals sent by a respective radio node of the one or more radio nodes are observable, at least partially overlap with the coverage of the area of the proximity geofence; and
utilizing the proximity geofence in a geofencing.

### Embodiment 12

The method according to embodiment 11, wherein the geofence enables triggering at least one geofence action that is part of the geofencing.

### Embodiment 13

The method according to embodiment 11 or embodiment 12, wherein the utilizing of the proximity geofence comprises:
gathering a radio scan of one or more radio signals sent by one or more radio nodes, wherein the one or more radio signals are observable at the position at which the apparatus is located; and
determining whether or not the second apparatus is located within the area, wherein the determining is at least partially based on the received proximity geofence and the gathered radio scan.

### Embodiment 14

The method according to embodiment 12 or embodiment 13, wherein the at least one geofence action is indicative of requesting a position estimate to be determined, wherein the position estimate is indicative of a current position of the apparatus and is determined at least partially based on the gathered radio scan.

### Embodiment 15

The method according to any of the embodiments 10 to 12, wherein the utilizing of the proximity geofence comprises:
receiving one or more geofence rules indicative of one or more geofence actions to be triggered in case a position of the apparatus when entering or exiting the area of the geofence;
determining whether or not one or more geofence rules are fulfilled at least partially based on the received proximity geofence; and
triggering the at least one geofence action based on the result of the determining.

### Embodiment 16

The method according to any of the embodiments 11 to 15, wherein the proximity geofence is further utilized to determine an uncertainty indicative of the position of the apparatus diverging from an actual position of the second apparatus.

### Embodiment 17

The method according to any of the embodiments 13 to 16, wherein the radio scan comprises extracting a respective identifier of a respective radio node which radio signals are observable at the position at which the apparatus is located.

### Embodiment 18

The method according to any of the embodiments 13 to 17, wherein the radio scan further comprises measuring a respective received signal strength value with which a respective radio signal of a respective radio node is observable at the position at which the apparatus is positioned.

### Embodiment 19

The method according to any of the embodiments 13 to 18, wherein the radio scan further comprises determining a number of radio nodes which respective radio signals are observable at the position at which the apparatus is located.

### Embodiment 20

The method according to any of the embodiments 11 to 19, wherein the at least one apparatus is a limited memory capability device, or a module or a component for a limited memory capability device.

### Embodiment 21

An apparatus configured to perform and/or control or comprising respective means for performing and/or controlling the method of any of the embodiments 1 to 10.

### Embodiment 22

An apparatus configured to perform and/or control or comprising respective means for performing and/or controlling the method of any of the embodiments 11 to 20.

### Embodiment 23

A system, comprising:
at least one first apparatus according to embodiment 21; and
at least one second apparatus according to embodiment 22.

### Embodiment 24

A first tangible computer-readable medium storing computer program code, the computer program code when executed by a processor causing an apparatus to perform and/or control:
generating a proximity geofence at least partially based on at least one stored radio map, wherein the proximity geofence is indicative of an area, wherein a limited memory capacity device is enabled to determine whether or not it is located within the area, wherein a geofence borders the area, wherein the proximity geofence is limited to comprising identifying information of one or more radio nodes which one or more respective coverage areas, in which radio signals sent by a respective radio node of the one or more radio nodes are observable, at least partially overlap with the coverage of the area of the proximity geofence, and wherein the at least one stored radio map is indicative of information identifying one or more radio nodes located in a geographical area that comprises the area of the proximity geofence; and providing the proximity geofence.

### Embodiment 25

A second tangible computer-readable medium storing computer program code, the computer program code when executed by a processor causing an apparatus to perform and/or control:
receiving a proximity geofence, wherein the proximity geofence is indicative of an area in which an apparatus is enabled to determine whether or not it is located within the area, wherein a geofence borders the area, wherein the proximity geofence is limited to comprising identifying information of one or more radio nodes which one or more respective coverage areas, in which radio signals sent by a respective radio node of the one or more radio nodes are observable, at least partially overlap with the coverage of the area of the proximity geofence; and
utilizing the proximity geofence in a geofencing.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are only exemplary, and that any feature presented for a particular example embodiment may be used with any aspect of the invention on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature of the invention and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of only one of the enumerated features is possible. The specific combination of all subsequently enumerated features may as well be considered. Also, a plurality of only one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The invention has been described above by means of example embodiments. It should be noted that there are alternative ways and variations which are obvious to a skilled person in the art and can be implemented without deviating from the scope of the appended claims.

1-19. (canceled)

20. An apparatus comprising at least one processor and at least one memory including computer program code, the at least one memory and the computer program code configured to, with the at least one processor, cause the apparatus to at least perform:
generating a proximity geofence at least partially based on at least one stored radio map, wherein the proximity geofence is indicative of an area, wherein a limited memory capacity device is enabled to determine whether or not it is located within the area, wherein a geofence borders the area, wherein the proximity geofence is limited to comprising identifying information of one or more radio nodes which one or more respective coverage areas, in which radio signals sent by a respective radio node of the one or more radio nodes are observable, at least partially overlap with the coverage of the area of the proximity geofence, and wherein the at least one stored radio map is indicative of information identifying one or more radio nodes located in a geographical area that comprises the area of the proximity geofence; and
providing the proximity geofence.

21. The apparatus according to claim 20, wherein the area is defined by one of the following:
i) geographical coordinates of the area that is bordered by the geofence; or
ii) by one or more identifiers of one or more radio nodes which respective one or more coverage areas form the area that is bordered by the geofence.

22. The apparatus according to claim 20, wherein the generating of the proximity geofence proximity geofence further comprises:
determining the one or more radio nodes that are located within the area at least partially based on the information identifying one or more radio nodes of the at least one stored radio map.

23. The apparatus according to claim 20, wherein the generating of the proximity geofence further comprises:
including one or more identifiers of the determined one or more radio nodes in the generated proximity geofence.

24. The apparatus according to claim 20, wherein the generating of the proximity geofence further comprises:
determining one or more position estimates, wherein each respective position estimate of the one or more position estimates is indicative of a position of one of the one or more radio nodes whose respective position is estimated to be located within the area.

25. The apparatus according to claim 23, wherein each respective position estimate of the one or more position estimate is determined at least partially based on the assumption that a respective radio node is located in the center of its respective coverage area.

26. The apparatus according to claim 22, wherein the generating of the proximity geofence further comprises:
including one or more received signal strengths values of the determined one or more radio nodes in the generated proximity geofence.

27. The apparatus according to claim 20, wherein the generated proximity geofence is provided to a limited memory capacity device.

28. The apparatus according to claim 20, the at least one memory and the computer program code configured to, with the at least one processor, cause the apparatus further to perform:
providing one or more geofence rules indicative of one or more geofence actions to be triggered in case the limited memory capability device enters or exits the area of the geofence; and/or receiving at least one geofence action comprising a request to assist the limited memory capacity device in performing the at least one geofence action.

29. An apparatus comprising at least one processor and at least one memory including computer program code, the at least one memory and the computer program code configured to, with the at least one processor, cause the apparatus to at least perform:
receiving a proximity geofence, wherein the proximity geofence is indicative of an area in which the second apparatus is enabled to determine whether or not it is located within the area, wherein a geofence borders the area, wherein the proximity geofence is limited to comprising identifying information of one or more radio nodes which one or more respective coverage areas, in which radio signals sent by a respective radio node of the one or more radio nodes are observable, at least partially overlap with the coverage of the area of the proximity geofence; and
utilizing the proximity geofence in a geofencing.

30. The apparatus according to claim 29, wherein the geofence enables triggering at least one geofence action that is part of the geofencing.

31. The apparatus according to claim 29, wherein the utilizing of the proximity geofence comprises:
gathering a radio scan of one or more radio signals sent by one or more radio nodes, wherein the one or more radio signals are observable at the position at which the second apparatus is located; and
determining whether or not the second apparatus is located within the area, wherein the determining is at least partially based on the received proximity geofence and the gathered radio scan.

32. The apparatus according to claim 30, wherein the at least one geofence action is indicative of requesting a position estimate to be determined, wherein the position estimate is indicative of a current position of the second apparatus and is determined at least partially based on the gathered radio scan.

33. The apparatus according to claim 29, wherein the utilizing of the proximity geofence in the geofencing further comprises:
receiving one or more geofence rules indicative of one or more geofence actions to be triggered in case a position of the apparatus when entering or exiting the area of the geofence;
determining whether or not one or more geofence rules are fulfilled at least partially based on the received proximity geofence; and
triggering the at least one geofence action based on the result of the determining.

34. The apparatus according to claim 32, wherein the proximity geofence is further utilized to determine an uncertainty indicative of the position of the second apparatus diverging from an actual position of the second apparatus.

35. The apparatus according to any of the claim 31, wherein the radio scan comprises extracting a respective identifier of a respective radio node which radio signals are observable at the position at which the apparatus is located.

36. The apparatus according to any of the claim 31, wherein the radio scan further comprises measuring a respective received signal strength value with which a respective radio signal of a respective radio node is observable at the position at which the apparatus is positioned.

37. The apparatus according to any of the claim 31, wherein the radio scan further comprises determining a number of radio nodes which respective radio signals are observable at the position at which the apparatus is located.

38. A system, comprising:
at least one processor and at least one memory including computer program code, the at least one memory and the computer program code configured to, with the at least one processor, cause at least one apparatus to at least perform:
generating a proximity geofence at least partially based on at least one stored radio map, wherein the proximity geofence is indicative of an area, wherein a limited memory capacity device is enabled to determine whether or not it is located within the area, wherein a geofence borders the area, wherein the proximity geofence is limited to comprising identifying information of one or more radio nodes which one or more respective coverage areas, in which radio signals sent by a respective radio node of the one or more radio nodes are observable, at least partially overlap with the coverage of the area of the proximity geofence, and wherein the at least one stored radio map is indicative of information identifying one or more radio nodes located in a geographical area that comprises the area of the proximity geofence;
receiving the proximity geofence, wherein the proximity geofence is indicative of an area in which the second apparatus is enabled to determine whether or not it is located within the area, wherein a geofence borders the area, wherein the proximity geofence is limited to comprising identifying information of one or more radio nodes which one or more respective coverage areas, in which radio signals sent by a respective radio node of the one or more radio nodes are observable, at least partially overlap with the coverage of the area of the proximity geofence; and
utilizing the proximity geofence in a geofencing.
